(19) United States
(12) Patent Application Publication
(10) Pub. No.: US 2009/0296007 A1
(43) Pub. Date: Dec. 3, 2009

(54) LIQUID CRYSTAL BLIND, METHOD OF MANUFACTURING SEMICONDUCTOR DEVICE USING THE SAME, AND REDUCED PROJECTION EXPOSURE APPARATUS

(75) Inventor: Fumiaki USHIYAMA, Fujimi (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/469,719

(22) Filed: May 21, 2009

(30) Foreign Application Priority Data
Jun. 3, 2008 (JP) 2008-145564
Mar. 24, 2009 (JP) 2009-072394

(51) Int. Cl. G02F 1/1335

(52) U.S. Cl. 349/4

(57) ABSTRACT

A liquid crystal blind includes a transparent first electrode layer, a transparent second electrode layer intersecting with the first electrode layer, and a liquid crystal cell formed between the first electrode layer and the second electrode layer, wherein the liquid crystal blind has an irradiation pattern, and a voltage is applied between the first electrode layer and the second electrode layer, thereby setting an irradiation area adapted to apply irradiation light to a semiconductor substrate and determining the irradiation pattern.

### BACKGROUND

1. Technical Field

Several aspects of the present invention relate to a liquid crystal blind used when performing reduced projection exposure on an exposed semiconductor substrate surface, a method of manufacturing a semiconductor device to which the liquid crystal blind is applied, and a reduced projection exposure apparatus.

2. Related Art

As the reduced projection exposure apparatus of this kind in the related art, the apparatus (the apparatus with a configuration not the invention known to the public by literature, but conceived to generally well known to the public) with a configuration shown in FIG. 10 can be cited.

In the case of this reduced projection exposure apparatus, light emitted from a mercury lamp 1 as a source of luminescence is reflected or collected by an elliptical mirror 2 to be formed as irradiation light, and the irradiation light with irradiation time controlled in accordance with an open/closed state of a shutter 3 is totally reflected by a total reflection mirror 4, only necessary wavelengths thereof are selected by an interference filter 5, and then the irradiation light is transmitted through a fly-eye lens 6 to be equalized in light intensity.

In a blind 7, an irradiation pattern of the irradiation light with the equalized light intensity is determined, the irradiation pattern is totally reflected by a total reflection mirror 8, and then transmitted through a condenser lens 9, thus the irradiation area thereof on a reticle 10 is determined. The condenser lens 9 transmits the irradiation light to irradiate the surface of the reticle 10, while forming the image of the irradiation pattern of the blind 7 on the reticle 10.

Further, the irradiation pattern on the reticle 10 passes through a product pattern area defined in a projection area in an opening section of the reticle 10, and is transmitted through a reduced projection lens 11 to be projected and exposed, as a resist pattern image of each of product chips, on a resist film surface (exposed semiconductor substrate surface) of a semiconductor wafer 13 held on a stage 12.

FIG. 11 is a schematic diagram presented for explaining setting of the irradiation area of the irradiation light applied on the reticle 10 using the blind 7 in this reduced projection exposure apparatus.

The blind 7 is composed of four segments, namely left, right, top, and bottom segments. Specifically, a top segment 7a, a bottom segment 7b, a left segment 7c, and right segment 7d are combined to form the opening section for setting the irradiation pattern. The image of the irradiation pattern is transmitted through the condenser lens 9 and then imaged on the reticle 10, as described above.

The four segments, namely the top segment 7a, the bottom segment 7b, the left segment 7c, and the right segment 7d are independently driven in predetermined directions to have a function of forming only a necessary part as the opening section and covering the other part for blocking light. FIG. 11 shows an action of the blind 7 driving the segments towards the center part to the position where only the part corresponding to a product pattern area Ep defined in the projection area (in an exposure shot surface) of the opening section of the reticle 10 is formed as the opening section, and the other part is covered, thereby forming a light blocking state, and fixing the state during the exposure.

FIG. 12 is a pattern diagram enlargedly exemplifying the details of the product pattern area Ep defined inside the projection area of the opening section of the reticle 10 here.

The drawing shows that product pattern area Ep is for arranging totally 16 product chips “a” through “p” as the resist pattern image on the resist film surface of the semiconductor wafer 13, and the product chips “a” through “p” are projected and exposed simultaneously by a single shot exposure. In the reduced projection exposure apparatus, since the irradiation time of the irradiation light necessary for the one shot exposure is controlled by the open/closed state of the shutter 3, and the blind 7 is fixed during the period in which the shutter 3 opens to apply the irradiation light, all of the product chips “a” through “p” existing in the product pattern area Ep of the reticle 10 are projected and exposed as the resist pattern on the resist film surface of the semiconductor wafer 13 with the same irradiation time.

Incidentally, as a technology well known to the public and related to the exposure apparatus explained hereinabove, there can be cited, for example, an apparatus (see JP-A-6-301190 (Abstract) (Document 1)) provided with a liquid crystal photomask having liquid crystal cells arranged continuously with no space therebetween to eliminate an uncontrollable area, thereby eliminating the need for electro-optical refresh operation.

In the case of the reduced projection exposure apparatus, since the irradiation area of the irradiation light applied on the reticle is set by driving the four segments, namely the top, bottom, left, and right segments of the blind in the predetermined directions, there is caused inconvenience that the shape of the opening section is limited to a rectangle, but not allowed to be set arbitrarily.

Further, since the shape of the opening section of the blind is fixed during the period in which the shutter is opened to apply the irradiation light, there is also caused inconvenience that it is not allowed to arbitrarily set the irradiation time in accordance with the irradiation area on the reticle.

Further, since the projection and exposure are performed in the product pattern area defined within the projection area on the reticle to which the same irradiation time is applied, there also arises a problem that the dimensional accuracy of the resist pattern image of the product chips existing in the product pattern area and thus projected and exposed is degraded in the exposure shot surface due to the influence of the illuminance variation, the aberration, and so on caused by the irradiation optical system and the projection optical system. It should be noted that although there can be considered a method of improving the performance of the reduced projection lens in order for improving the dimensional accuracy of such a resist pattern image, since the reduced projection lens is generally an extremely expensive product having a structure with a plurality of lenses combined exquisitely, according to some circumstances, such a method is inadvisable.

In other words, in the related art, it is difficult to flexibly control the irradiation light applied on the reticle.

It should be noted that since the liquid crystal photomask of the Document 1, having the structure with the liquid crystal cells arranged continuously with no space therebetween uses the liquid crystal cells for exposing an integrated circuit pattern, and therefore, the problems described above also exist in the technology described in the Document 1 in a similar fashion.

### SUMMARY

Therefore, an advantage of the invention is to flexibly control the irradiation light applied on the reticle.

A liquid crystal blind according to a first aspect of the invention includes a transparent first electrode layer, a transparent second electrode layer intersecting with the first electrode layer, and a liquid crystal cell formed between the first electrode layer and the second electrode layer, wherein the liquid crystal blind has an irradiation pattern, and a voltage is applied between the first electrode layer and the second electrode layer, thereby setting an irradiation area adapted to apply irradiation light to a semiconductor substrate and determining the irradiation pattern.

Further, in the liquid crystal blind described above, the liquid crystal cell can be controlled so as to determine an irradiation time in accordance with the irradiation area.

A method of manufacturing a semiconductor device according to another aspect of the invention is a method of manufacturing a semiconductor device using a liquid crystal blind having a plurality of liquid crystal cells and driven by a liquid crystal drive method. The method of manufacturing a semiconductor device includes the steps of (a) setting an exposure condition, and (b) conducting projection exposure. In step (a), an irradiation pattern is determined by applying a voltage to each of the liquid crystal cells, and in step (b), the projection exposure is conducted via the irradiation pattern.

Further, in the method of manufacturing a semiconductor device, the liquid crystal blind may further include a first electrode layer extending in a first direction and a second electrode layer extending in a second direction intersecting with the first direction, and the irradiation pattern may be formed by controlling a voltage application to the first electrode layer and the second electrode layer.

Further, in the method of manufacturing a semiconductor device, the voltage application can be controlled based on irradiation time data corresponding to an area on which the projection exposure is conducted.

Further, in the method of manufacturing a semiconductor device, the step of (c) setting entire surface light-blocking state may be further included, and step (c) may be conducted before and after conducting the projection exposure.

A reduced projection exposure apparatus according to still another aspect of the invention includes a liquid crystal blind having a plurality of liquid crystal cells and driven by a liquid crystal drive method, a storage device, and a controller, and the storage device stores an exposure control program, and the controller, with the exposure control program, determines an irradiation pattern and sets an exposure condition to the liquid crystal blind.

A liquid crystal blind, a method of manufacturing a semiconductor device to which the liquid crystal blind is applied, and a reduced projection exposure apparatus according to still other aspects of the invention can be described as follows.

First one is a liquid crystal blind having a function of variably setting an irradiation pattern for setting an irradiation area of the irradiation light applied on a reticle when conducting reduced projection exposure on an exposed semiconductor substrate surface, and variably setting the irradiation area by being driven by the liquid crystal drive method. According to such a configuration, since the structure is driven by the liquid crystal drive method, it becomes possible to variably set the shape of the irradiation area of the irradiation light applied on the reticle. In other words, it becomes possible to flexibly control the irradiation light applied on the reticle.

Second one is a liquid crystal blind having a liquid crystal cell structure in which liquid crystal is held between a layer provided with strip-shaped transparent lengthwise electrodes extending in a lengthwise direction in parallel to each other, and a layer provided with strip-shaped transparent lateral electrodes extending in a lateral direction in parallel to each other, and in the liquid crystal cell structure, the orientations of the liquid crystal molecules are aligned in response to a voltage application between the lengthwise electrode and the lateral electrode, thereby forming an optical opening section having light transmission, which can selectively be controlled for each of the liquid crystal cells, as the irradiation area. According to such a configuration as described above, since transmission and blocking of the light can be controlled for each of the liquid crystal cells by applying (applying write signals) voltages to the lengthwise electrodes and the lateral electrodes corresponding to the respective liquid crystal cells, the shape of the irradiation area of the irradiation light can arbitrarily be set using the optical opening section.

Third one is a liquid crystal blind in which the open/closed state of the optical opening section can partially be controlled so that the irradiation time can arbitrarily be set in accordance with the irradiation area. According to such a configuration as described above, by providing some levels of the irradiation time of the irradiation light in the optical opening section to vary the shape of the irradiation area between the levels, it is possible to arbitrarily control the irradiation time in accordance with the irradiation area on the reticle. As a result, since the exposure energy in the projection area can be set as an appropriate value and partially controlled in accordance with the irradiation area on the reticle, the influence of the illuminance variation, the aberration, and so on caused by the irradiation optical system and the projection optical system in the reduced projection exposure apparatus can be eliminated, and the dimensional accuracy of the resist pattern image projected and exposed as each of the product chips existing in the product pattern area defined in the projection area (in the exposure shot surface) of the reticle can remarkably be improved in the exposure shot surface. In other words, according to the aspect of the invention, it is possible to provide a liquid crystal blind having a structure in which the shape of the irradiation area of the irradiation light applied on the reticle and the irradiation time corresponding to the irradiation area can arbitrarily be set, and the dimensional accuracy of the resist pattern image projected and exposed can be kept preferable (roughly uniform) in the exposure shot surface.

Fourth one is a method of manufacturing a semiconductor device including an exposure condition setting step of conducting a control of a voltage application to a lengthwise transparent electrode and a lateral transparent electrode corresponding to an address of the liquid crystal cell on the liquid crystal blind based on the irradiation area data for determining the irradiation area and the irradiation time data for determining the irradiation time in accordance with the irradiation area to the liquid crystal blind having a function of variably setting the irradiation pattern for setting the irradiation area of the irradiation light applied on reticle when conducting reduced projection exposure on exposed semiconductor substrate surface, driven by the liquid crystal drive method, and variably setting the irradiation area, and determining the irradiation pattern representing the light transmission for each of the liquid crystal cells, thereby setting the exposure condition, and the projection exposure step of making the irradiation light, on which the exposure condition is set, pass through the projection area of the reticle via the liquid crystal blind, and further pass through the reduced projection lens and projecting and exposing the irradiation light on the exposed semiconductor substrate surface. According to such a method as described above, since the shape of the irradiation area of the irradiation light applied on the reticle and the irradiation time corresponding to the irradiation area can arbitrarily be set, and the dimensional accuracy of the resist pattern image thus projected and exposed can be kept roughly uniform in the exposure shot surface, the difference in pattern dimension between the product chips can be suppressed to a small value, and it is possible to manufacture a high quality semiconductor device having a resist pattern superior in dimensional accuracy with good yield and ease.

Fifth one is a method of manufacturing a semiconductor device in which the irradiation area data used in the exposure condition setting step includes entire surface light-blocking data for setting the inside of the projection area to be an entire surface light blocking state when the projection exposure is not conducted, and the liquid crystal blind is controlled to set the inside of the projection area to be the entire surface light-blocking state based on the entire surface light-blocking data before and after the irradiation of the irradiation light obtained by the light emission in the source of luminescence. According to such a method as described above, when, for example, the entire optical opening section of the liquid crystal blind is set to be the closed state based on the entire surface light-blocking data before and after the irradiation of the irradiation light, namely when no projection exposure is conducted, the inside of the projection area of the reticle is set to be the entire surface light-blocking state to make it possible to obtain the function of the shutter, and therefore, it becomes possible to eliminate the need for using the shutter in the irradiation optical system.

Sixth one is a reduced projection exposure apparatus including a liquid crystal blind having a function of variably setting an irradiation pattern for setting an irradiation area of the irradiation light applied on a reticle when conducting reduced projection exposure on an exposed semiconductor substrate surface, and variably setting the irradiation area when being driven by the liquid crystal drive method, a storage device adapted to store irradiation area data for determining the irradiation area, irradiation time data for determining the irradiation time according to the irradiation area, electrode arrangement data showing the arrangement of the lengthwise transparent electrodes and the lateral transparent electrodes corresponding to the respective addresses of the liquid crystal cells, and an exposure control program for determining an irradiation pattern representing the light transmission values in the respective liquid crystal cells and setting the exposure condition, and a controller adapted to conduct the exposure control program to control voltage application to the lengthwise transparent electrodes and the lateral transparent electrodes corresponding to the addresses of the liquid crystal cells represented by the electrode arrangement data in accordance with the irradiation area data and the irradiation time data with respect to the liquid crystal blind, and to determine the irradiation pattern representing the light transmission for each of the liquid crystal cells. According to such a configuration as described above, due to the actions of the storage device and the controller, similarly to the fourth one, since the shape of the irradiation area of the irradiation light applied on the reticle and the irradiation time corresponding to the irradiation area can arbitrarily be set, and the dimensional accuracy of the resist pattern image thus projected and exposed can be kept roughly uniform in the exposure shot surface, the difference in pattern dimension between the product chips can be suppressed to a small value, and it is possible to manufacture a high quality semiconductor device having a resist pattern superior in dimensional accuracy with good yield and ease.

Seventh one is a reduced projection exposure apparatus wherein the irradiation light in which the exposure condition is set is transmitted through the projection area of the reticle, further transmitted through the reduced projection lens, and provided for projection exposure on the exposed semiconductor substrate surface, the irradiation area data stored in the storage device includes entire surface light-blocking data for setting the inside of the projection area to be the entire surface light-blocking state when the projection exposure is not conducted, and the controller controls the liquid crystal blind based on the entire surface light-blocking data before and after the irradiation of the irradiation light obtained by the light emission in the source of luminescence to set the inside of the projection area to be the entire surface light-blocking state. According to such a configuration as described above, since it is possible to set the inside of the projection area of the reticle to be the entire surface light-blocking state to have the role of the shutter due to the actions of the storage device and the controller, similarly to the case of the fifth one, the need for using the shutter in the irradiation optical system can be eliminated.

Eighth one is a reduced projection exposure apparatus including a shutter capable of controlling the irradiation time of the irradiation light obtained by the light emission in the source of luminescence by the open/closed state thereof, and the controller performs the open/close control of the shutter. According to such a configuration as described above, since the shutter of the irradiation optical system is provided as in the past, the controller is made to perform open/close control of the shutter so that an incident light with appropriate irradiation time can be obtained in the liquid crystal blind, and it is also possible to make the controller perform the control of voltage application to the liquid crystal blind for variably setting the irradiation area of the irradiation light applied on the reticle in a follow-up manner, it is possible to make the controller perform the assurance of the dimensional accuracy of the resist pattern image by the projection exposure in a more stable manner.

### BRIEF DESCRIPTION OF THE DRAWINGS

The invention will now be described with reference to the accompanying drawings, wherein like numbers reference like elements.

FIG. 1 is a schematic diagram showing a basic configuration of a reduced projection exposure apparatus according to a first embodiment of the invention.

FIG. 2 is a plan view showing a fundamental structure of a liquid crystal blind 17 as an essential part of the reduced projection exposure apparatus shown in FIG. 1 with a part thereof broken.

FIG. 3 is a side cross-sectional view of the liquid crystal blind 17 along the direction of the A-A′ line shown in FIG. 2.

FIG. 4 is a side cross-sectional view of the liquid crystal blind 17 along the direction of the B-B′ line shown in FIG. 2.

FIGS. 5A and 5B are diagrams exemplifying a product pattern area Ep varied by an irradiation pattern on the reticle 10, on which irradiation control by the liquid crystal blind 17 in the reduced projection exposure apparatus shown in FIG. 1 is conducted, wherein FIG. 5A is related to an entire area irradiation pattern, and FIG. 5B is related to a partial area irradiation pattern.

FIGS. 6A and 6B are diagrams exemplifying measurement results of the dimensions of the resist pattern projected and exposed on the resist film surface of the semiconductor wafer 13 in the cases shown in FIGS. 5A and 5B, wherein FIG. 6A is related to the dimensions of the resist pattern of the respective product chips of the entire area irradiation pattern, and FIG. 6B is related to the dimensions of the resist pattern of the respective product chips of the partial area irradiation pattern.

FIG. 7 is a characteristic diagram showing a relationship of the resist dimension (resist pattern dimension) [m] with respect to the exposure (irradiation) time [msec] in the reduced projection exposure apparatus shown in FIG. 1.

FIGS. 8A through 8E are diagrams exemplifying the product pattern area Ep varied in accordance with the irradiation pattern on the reticle 10, on which the irradiation control by the liquid crystal blind 17 in the reduced projection exposure apparatus according to a second embodiment of the invention is conducted, wherein FIG. 8A is related to the entire area irradiation pattern, FIG. 8B is related to a first partial area irradiation pattern, FIG. 8C is related to a second partial area irradiation pattern, FIG. 8D is related to a third partial area irradiation pattern, and FIG. 8E is related to an entire area non-irradiation pattern.

FIG. 9 is a diagram exemplifying the measurement results of the resist pattern dimensions of the respective product chips (a through p) projected and exposed on the resist film surface of the semiconductor wafer 13 in the cases shown in FIGS. 8A through 8E.

FIG. 10 is a schematic diagram showing a basic configuration of the reduced projection exposure apparatus of the related art.

FIG. 11 is a schematic diagram presented for explaining setting of the irradiation area of the irradiation light applied on the reticle using the blind in the reduced projection exposure apparatus shown in FIG. 10.

FIG. 12 is a pattern diagram enlargedly exemplifying the details of the product pattern area Ep defined inside the projection area of the opening section of the reticle explained with reference to FIG. 11.

### DESCRIPTION OF EXEMPLARY EMBODIMENTS

Hereinafter, some embodiments of a liquid crystal blind, a method of manufacturing a semiconductor device to which the liquid crystal blind is applied, and a reduced projection exposure apparatus will be explained with reference to the accompanying drawings.

### First Embodiment

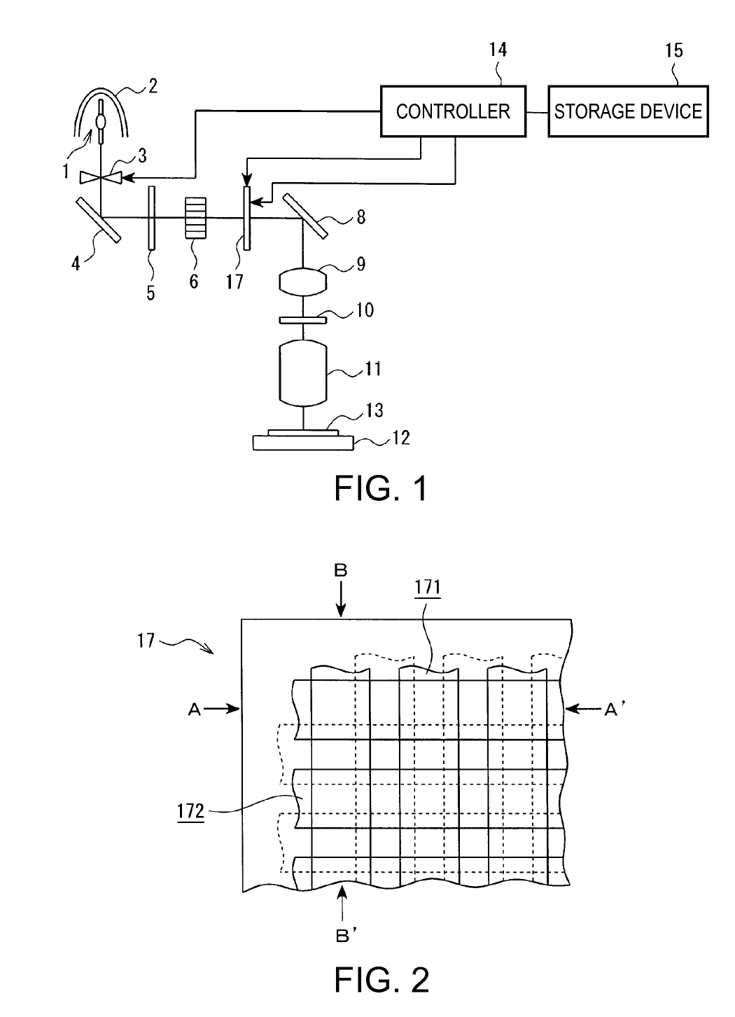

FIG. 1 is a schematic diagram showing a basic configuration of a reduced projection exposure apparatus according to the first embodiment of the invention. Further, FIG. 2 is a plan view showing a fundamental structure of a liquid crystal blind 17 as an essential part of the reduced projection exposure apparatus with a part thereof broken.

The reduced projection exposure apparatus is provided with a mercury lamp 1 as a source of luminescence, an elliptical mirror 2 for reflecting and collecting the light emitted by the mercury lamp 1 to form irradiation light, a shutter 3 for controlling the irradiation time of the irradiation light in accordance with an open/closed state, a total reflection mirror 4 for totally reflecting the irradiation light from the shutter 3 in a lengthwise direction, an interference filter 5 for transmitting the irradiation light totally reflected by the total reflection mirror 4 to select only necessary wavelengths, a fly-eye lens 6 for transmitting the irradiation light with the wavelengths selected by the interference filter 5 to equalize the light intensity, the liquid crystal blind 17 driven by the liquid crystal driving method, and having a function of variably setting an irradiation pattern of the irradiation light with the equalized light intensity, and a total reflection mirror 8 for totally reflecting the irradiation light with the irradiation pattern from the liquid crystal blind 17 towards the lengthwise direction.

Among these constituents, the liquid crystal blind 17 has a liquid crystal sell structure having liquid crystal material held between a layer provided with strip-shaped lengthwise transparent electrodes 171 extended in a lengthwise direction and in parallel to each other and a layer provided with strip-shaped lateral transparent electrodes 172 extended laterally and in parallel to each other.

In the liquid crystal cell structure, the orientations of the liquid crystal molecules are aligned in accordance with application of a voltage between the lengthwise transparent electrodes 171 and the lateral transparent electrodes 172, thereby forming an optical opening section having the light transmission, which can selectively controlled for each of the liquid crystal cells, as the irradiation area.

In other words, in the case of this liquid crystal blind 17, by being driven by the liquid crystal drive method to variably set the irradiation pattern of the irradiation light, it becomes possible to variably set the shape of the irradiation area of the irradiation light applied on the reticle 10.

Specifically, since transmission and blocking of the light can be controlled for each of the liquid crystal cells by applying (applying write signals) voltages to the lengthwise transparent electrodes 171 and the lateral transparent electrodes 172 corresponding to the respective liquid crystal cells, the shape of the irradiation area of the irradiation light can arbitrarily be set using the optical opening section.

Further, the reduced projection exposure apparatus is provided with a condenser lens 9 for transmitting the irradiation light totally reflected by the total reflection mirror 8, and imaging an image of the irradiation pattern thereof on the reticle 10, the reticle 10 for defining the irradiation pattern transmitted through the condenser lens 9 as the product pattern area within the projection area (within the exposure shot surface) of the opening section, a reduced projection lens 11 for transmitting the irradiation light defined as the product pattern area from the reticle 10 so as to conduct the reduced projection, and then projecting and exposing it on the exposed semiconductor substrate surface as the resist pattern image, a table 12 for mounting the exposed semiconductor substrate, and a semiconductor wafer 13 as the exposed semiconductor substrate on which the resist pattern image of the product pattern area is projected and exposed.

Further, this reduced projection exposure apparatus is provided with a storage device 15 storing irradiation area data for determining the irradiation area, irradiation time data for determining the irradiation time corresponding to the irradiation area, electrode arrangement data showing the arrangement of the lengthwise transparent electrodes 171 and the lateral transparent electrodes 172 corresponding to the addresses of the liquid crystal cells, and an exposure control program for determining the irradiation pattern representing the light transmission of each of the liquid crystal cells, thereby setting the exposure conditions, and a controller 14 for transmitting a control signal to the chatter 3 to perform the open/close control, conducting the exposure control program to transmit, to the liquid crystal blind 17, a control signal for applying voltages to the lengthwise transparent electrode 171 and the lateral transparent electrode 172 corresponding to the address of the liquid crystal cell represented by the electrode arrangement data in accordance with the irradiation area data and the irradiation time data, and determining the irradiation pattern representing the light transmission in each of the liquid crystal cells, thereby setting the exposure conditions.

By the controller 14 conducting the exposure control program at this point, it is arranged that the optical opening section in the liquid crystal blind 17 is partially controlled in the open/close state so that the irradiation time can arbitrarily be set in accordance with the irradiation area.

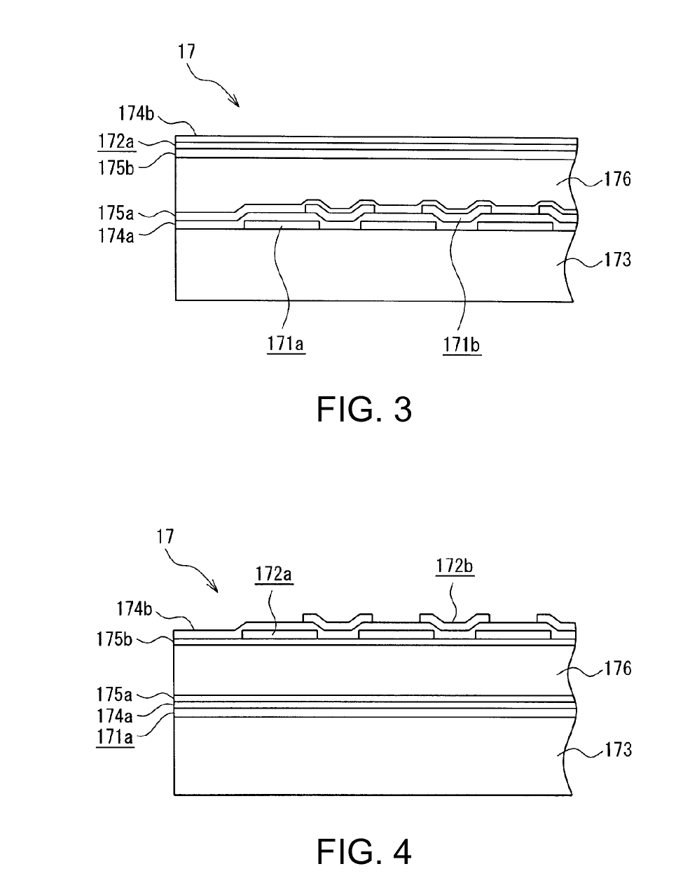

FIG. 3 is a side cross-sectional view of the liquid crystal blind 17 along the direction of the A-A′ line shown in FIG. 2. Further, FIG. 4 is a side cross-sectional view of the liquid crystal blind 17 along the direction of the B-B′ line shown in FIG. 2.

Here, the detailed structure of the liquid crystal blind 17 is shown, and the lengthwise transparent electrode 171 and the lateral transparent electrode 172 each have a two-layer structure having an insulating film intervening therein on a substrate having light transmission, the structure having oriented films 175a, 175b intervening on the liquid crystal 176 side of the respective two-layer structures.

For example, the substrate having light transmission is a quartz substrate 173, and the lengthwise transparent electrode 171 has a multilayer structure obtained by forming a first lengthwise transparent electrode 171a on the quartz substrate 173 using tin-doped indium oxide (ITO), then forming a first insulating film 174a thereon with silicon dioxide (SiO₂) or the like, and then forming a second lengthwise transparent electrode 171b thereon using similarly indium oxide (ITO). On the second lengthwise transparent electrode 171b, a first oriented film 175a with a PIQ film or the like is formed, the liquid crystal 176 in the liquid crystal cell structure is formed thereon, and a second oriented film 175b with a PIQ film or the like is formed further thereon.

Further, the lateral transparent electrode 172 has substantially the same configuration, which is a multilayer structure obtained by forming a first lateral transparent electrode 172a on the second oriented film 175b using tin-doped indium oxide (ITO), then forming a second insulating film 174b thereon with silicon dioxide (SiO₂) or the like, and then forming a second lateral transparent electrode 172b thereon using similarly indium oxide (ITO).

In other words, the liquid crystal blind 17 has a structure of holding the liquid crystal 176 between the lengthwise transparent electrodes 171a, 171b forming a two-layer structure and the lateral transparent electrodes 172a, 172b with the first oriented film 175a and the second oriented film 175b intervening therebetween. By applying a write signal (a control signal of voltage application) to the lengthwise transparent electrodes 171a, 171b and the lateral transparent electrodes 172a, 172b corresponding to the address of the liquid crystal cell of the liquid crystal 176, the orientation of the liquid crystal molecules can be controlled, and as a result, it becomes possible to selectively control transmission and blocking of the irradiation light for each of the liquid crystal cells.

Also in the case of this reduced projection exposure apparatus, the light emitted from the mercury lamp 1 as a source of luminescence is reflected or collected by the elliptical mirror 2 to be formed as the irradiation light, and the irradiation light with the irradiation time controlled in accordance with the open/closed state of the shutter 3 controlled by the controller 14 is totally reflected by the total reflection mirror 4, only necessary wavelengths thereof are selected by the interference filter 5, and then the irradiation light is transmitted through the fly-eye lens 6 to be equalized in light intensity.

Further, in the liquid crystal blind 17, selection of the X, Y coordinate position of the liquid crystal cell structure, and control of the light transmission by the electro-optical control of the liquid crystal cell located on the coordinate position thus selected are performed in accordance with the control signal from the controller 14 to the lengthwise transparent electrodes 171 (171a, 171b) and the lateral transparent electrodes 172 (172a, 172b), and as a result, the irradiation pattern of the irradiation light is determined in a variable manner. Then, the variable irradiation pattern is totally reflected by the total reflection mirror 8, and then transmitted through the condenser lens 9, thus the irradiation area on the reticle 10 is determined in a variable manner. The condenser lens 9 transmits the irradiation light to irradiate the surface of the reticle 10, while forming the image of the variable irradiation pattern of the liquid crystal blind 17 on the reticle 10.

Further, the variable irradiation pattern on the reticle 10 passes through the product pattern area defined in the projection area in the opening section of the reticle 10, and is transmitted through the reduced projection lens 11 to be projected and exposed, as a resist pattern image of each of the product chips, on the resist film surface (exposed semiconductor substrate surface) of the semiconductor wafer 13 held on the stage 12.

In the case of the reduced projection exposure apparatus, the shape of the irradiation area of the irradiation light applied on the reticle 10 in the liquid crystal blind 17 and the irradiation time corresponding to the irradiation area are set arbitrarily due to the action of the storage device 15 and the controller 14.

Thus, since the dimensional accuracy of the resist pattern image projected and exposed on the resist film surface of the semiconductor wafer 13 can be kept roughly uniform in the exposure shot surface, the difference in pattern dimension between the product chips can be suppressed to a small value, and it is possible to manufacture a high quality semiconductor device having a resist pattern superior in dimensional accuracy with good yield and ease.

In other words, by providing some levels of the irradiation time of the irradiation light in the optical opening section of the liquid crystal blind 17 and varying the shape of the irradiation area in accordance with the levels due to the action of the storage device 15 and the controller 14, it is possible to arbitrarily control the irradiation time in accordance with the irradiation area on the reticle 10, and it is also possible to set the exposure energy inside the projection area of the reticle 10 to be an appropriate value, and to partially control the exposure energy.

Therefore, the influence of the illuminance variation, the aberration, and so on caused by the irradiation optical system and the projection optical system in the reduced projection exposure apparatus can be eliminated, the dimensional accuracy of the resist pattern image projected and exposed as the product chips existing in the product pattern area defined in the projection area (in the exposure shot surface) of the reticle 10 can remarkably be improved in the exposure shot surface.

Therefore, according to the reduced projection exposure apparatus equipped with the liquid crystal blind 17 related to the first embodiment, the shape of the irradiation area of the irradiation light applied on the reticle 10 and the irradiation time corresponding to the irradiation area can arbitrarily be set, and the dimensional accuracy of the resist pattern image projected and exposed can be kept preferable (roughly uniform) in the exposure shot surface.

Hereinafter, the technology for improving the dimensional accuracy of the resist pattern image in the reduced projection exposure apparatus according to the first embodiment will more specifically be explained.

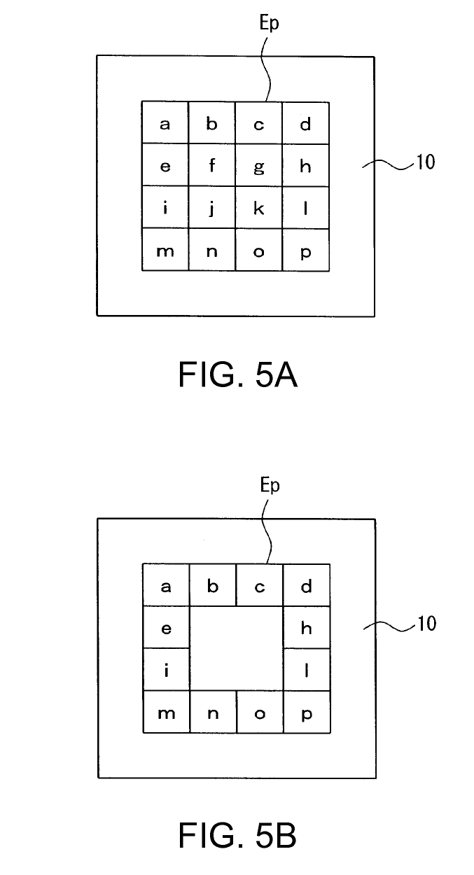

FIGS. 5A and 5B are diagrams exemplifying a product pattern area Ep varied by the irradiation pattern on the reticle 10, on which the irradiation control by the liquid crystal blind 17 in the present reduced projection exposure apparatus is conducted, wherein FIG. 5A is related to an entire area irradiation pattern, and FIG. 5B is related to a partial area irradiation pattern.

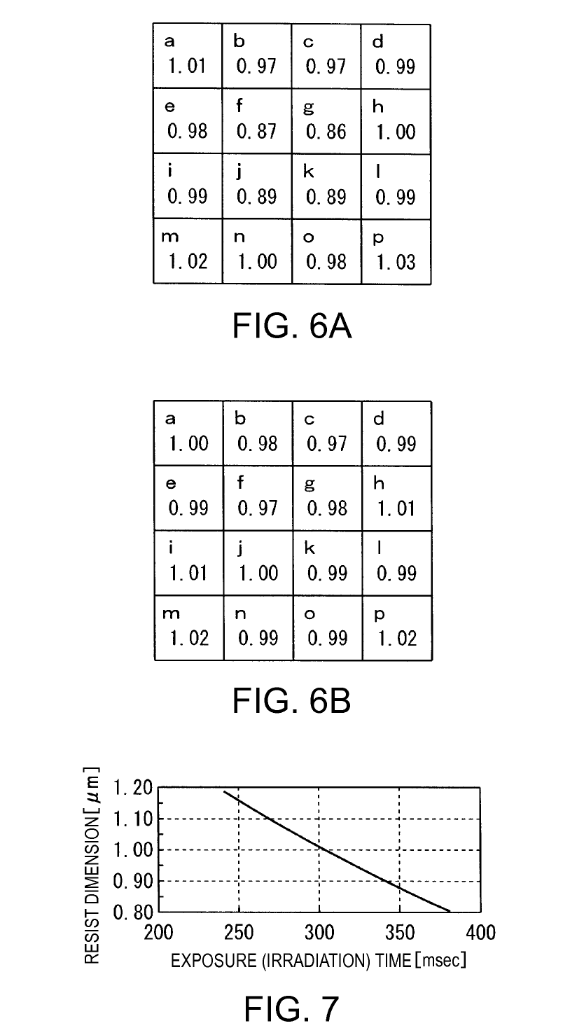

Further, FIGS. 6A and 6B are diagrams exemplifying measurement results of the dimensions of the resist pattern projected and exposed on the resist film surface of the semiconductor wafer 13 in the cases shown in FIGS. 5A and 5B, wherein FIG. 6A is related to the dimensions of the resist pattern for the respective product chips of the entire area irradiation pattern, and FIG. 6B is related to the dimensions of the resist pattern for the respective product chips of the partial area irradiation pattern.

Further, FIG. 7 is a characteristic diagram showing a relationship of the resist dimension (resist pattern dimension) [m] with respect to the exposure (irradiation) time [msec] in the present reduced projection exposure apparatus. It is assumed that the characteristic data is stored in the storage device 15.

Here, in the reduced projection exposure apparatus, the controller 14 firstly provides the lengthwise transparent electrodes 171 (171a, 171b) and the lateral transparent electrodes 172 (172a, 172b) corresponding to the address of the liquid crystal cell of the liquid crystal blind 17 with the write signal along the exposure control program stored in the storage device 15, and performs the control so that the entire product chips (a through p) existing in the product pattern area Ep as the entire area irradiation pattern shown in FIG. 5A becomes the irradiation area.

Subsequently, since the design value of the dimension of the resist pattern in each of the product chips (a through p) is 1 μm, the controller 14 reading the necessary exposure (irradiation) time of 300 msec (shown in FIG. 7) from the characteristic data stored in the storage device 15 controls the open/closed state of the shutter 3 to apply the irradiation light for 300 msec. It should be noted that although the dimension of the resist pattern of each of the product chips (a through p) having been projected and exposed must originally be finished to be 1 μm, the dimensional accuracy in the exposure surface may sometimes be degraded dramatically under the influence of the illuminance variation, the aberration, and so on due to the irradiation optical system and the projection optical system of the apparatus.

FIG. 6A shows measurement results of the dimensions of the product chips (a through p) projected and exposed in such a procedure. With reference to FIG. 6A, it is understood that the dimension of the resist pattern of each of the product chips (f, g, j, k) located at the shot center section has a distribution about 0.1 μm thinner compared to those of the product chips (a, b, c, d, e, h, i, l, m, n, o, p) in the peripheral area thereof, and that the average dimension of the product chips (a through p) in the exposure shot surface is 0.97 μm, and the dimensional accuracy thereof is 17.6%.

When estimating the optimum exposure (irradiation) time of each of the product chips (a through p) from the characteristic diagram shown in FIG. 7 based on the results shown in FIG. 6A, regarding the product chips (f, g, j, k) located at the shot center section, since the average dimension thereof is 0.88 μm, it is the optimum to set the exposure time to be 260 msec in order for making the dimension increase by 0.12 μm, and regarding the product chips (a, b, c, d, e, h, i, l, m, n, o, p) in the peripheral area thereof, since the average dimension is 0.99 μm, it is the optimum to perform projection and exposure for 300 msec as it is.

Therefore, in the reduced projection exposure apparatus according to the first embodiment, in the 300 msec period during which the shutter 3 is kept in the open state, the optical opening section of the liquid crystal blind 17 is controlled in two levels due to the action of the storage device 15 and the controller 14 to variably set the shape of the irradiation area of the irradiation light. Specifically, the entire product chips (a through p) shown in FIG. 5A are taken as the irradiation object in the beginning 260 msec, and then only the product chips (a, b, c, d, e, h, i, l, m, n, o, p) in the peripheral area other than the product chips (f, g, j, k) located at the shot center section are taken as the irradiation object as shown in FIG. 5B in the remaining 40 msec.

FIG. 6B shows measurement results of the dimensions of the product chips (a through p) projected and exposed while variably setting the irradiation area in such a procedure. With reference to FIG. 6B, it is understood that the average dimension of the product chips (a through p) in the exposure shot surface becomes 0.99 μm, which is closer to the design value of 1.00 μm, the dimensional accuracy is improved to be 5.0%, and the influence of the illuminance variation, the aberration, and so on caused by the irradiation optical system and the projection optical system of the apparatus is eliminated.

The technically essential point of the reduced projection exposure apparatus according to the first embodiment explained above can be rephrased as a method of manufacturing the semiconductor device to which the liquid crystal blind 17 with the liquid crystal drive method described above is applied, and specifically, it can be said that the technically essential point is a method of manufacturing the semiconductor device including an exposure condition setting stage for controlling application of a voltage to the lengthwise transparent electrode 171 and the lateral transparent electrode 172 corresponding to the address of the liquid crystal cell with respect to the liquid crystal blind 17 along the irradiation area data for determining the irradiation area and the irradiation time data for determining the irradiation time corresponding to the irradiation area, thereby determining the irradiation pattern representing the light transmission of the liquid crystal cell to set the exposure conditions, and a projecting and exposing stage for transmitting the irradiation light to which the exposure condition has been set through the projection area of the reticle 10, further transmitting the irradiation light through the reduced projection lens 11, and then projecting and exposing the irradiation light on the exposed semiconductor substrate surface.

According to the method described above, the shape of the irradiation area of the irradiation light applied on the reticle 10 and the irradiation time corresponding to the irradiation area can arbitrarily be set, thus it becomes possible to flexibly control the irradiation light applied on the reticle.

Therefore, since the dimensional accuracy of the resist pattern image projected and exposed on the resist film surface of the semiconductor wafer 13 can be kept roughly uniform in the exposure shot surface, the difference in pattern dimension between the product chips (a through p) can be suppressed to a small value, and it is possible to manufacture a high quality semiconductor device having a resist pattern superior in dimensional accuracy with good yield and ease.

### Second Embodiment

In the case of the reduced projection exposure apparatus according to the first embodiment, the case in which the optical opening section of the liquid crystal blind 17 is controlled in two levels due to the action of the storage device 15 and the controller 14, thereby variably setting the shape of the irradiation area of the irradiation light is explained. In the second embodiment, the control with finer levels is performed, thereby variably setting the shape of the irradiation area.

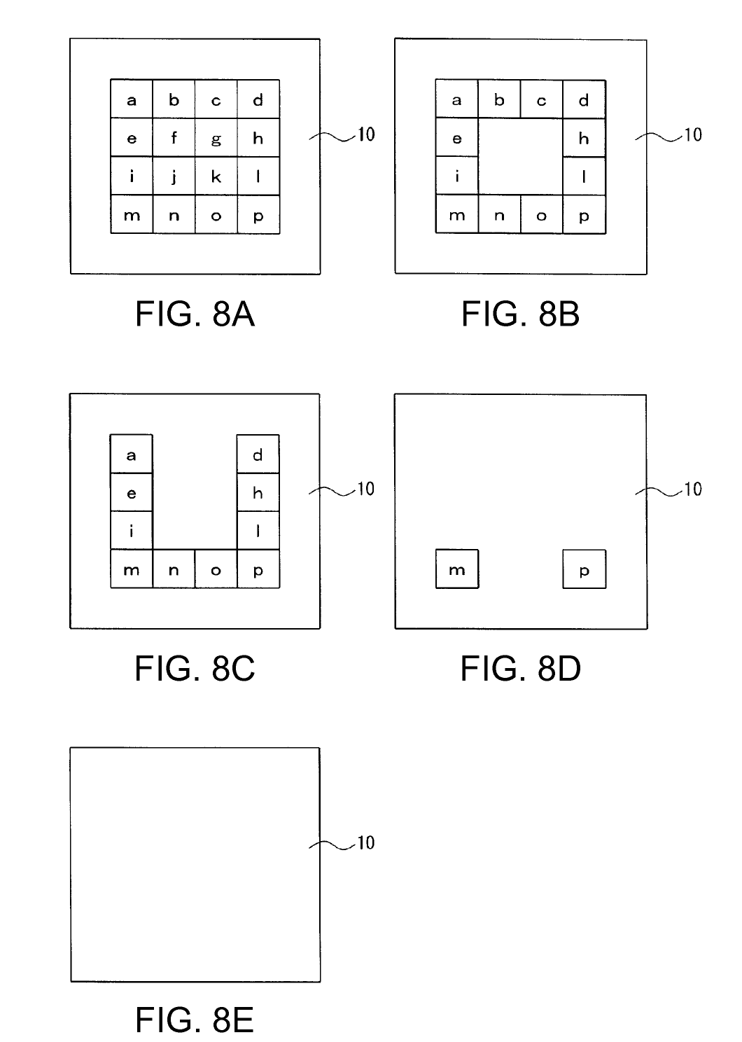

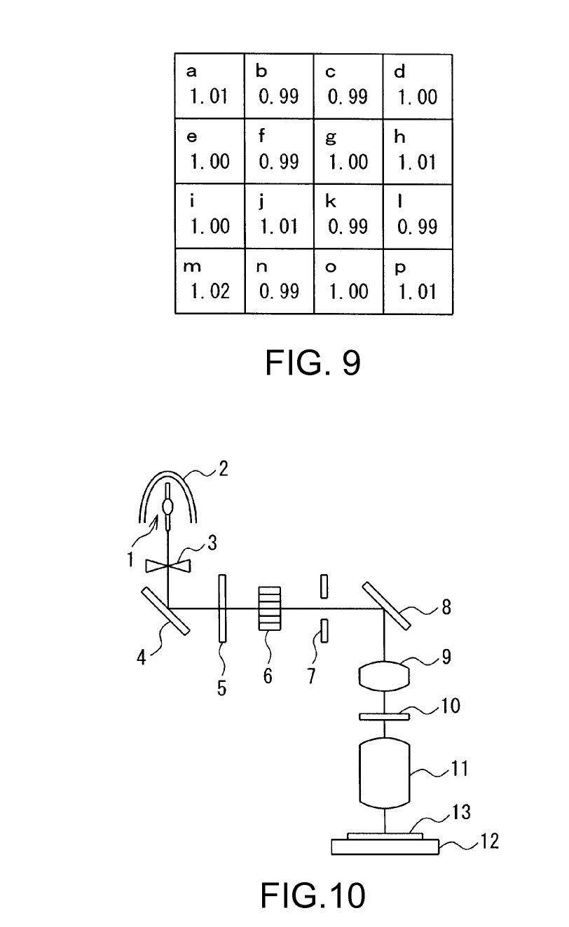

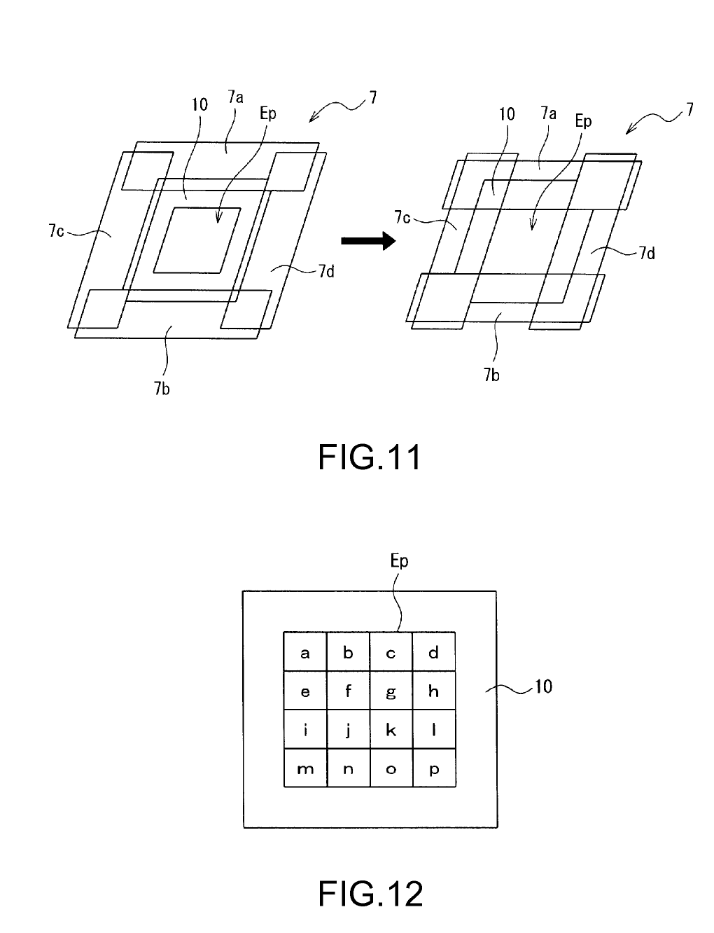

FIGS. 8A through 8E are diagrams exemplifying the product pattern area Ep varied in accordance with the irradiation pattern on the reticle 10, on which the irradiation control by the liquid crystal blind 17 in the reduced projection exposure apparatus according to the second embodiment of the invention is conducted, wherein FIG. 8A is related to the entire area irradiation pattern, FIG. 8B is related to a first partial area irradiation pattern, FIG. 8C is related to a second partial area irradiation pattern, FIG. 8D is related to a third partial area irradiation pattern, and FIG. 8E is related to an entire area non-irradiation pattern. Further, FIG. 9 is a diagram exemplifying the measurement results of the resist pattern dimensions of the respective product chips (a through p) projected and exposed on the resist film surface of the semiconductor wafer 13 in the cases shown in FIGS. 8A through 8E.

Here, focusing attention on the measurement results of the dimensions of the resist pattern shown in FIG. 6A explained in the first embodiment described above, the product chips (a through p) are classified into four groups based on the amplitude value of the dimension of the resist pattern, and the exposure (irradiation) time the most suitable for each group is estimated based on the relationship in the characteristic diagram shown in FIG. 7.

Specifically, regarding the product chips (f, g, j, k) located at the shot center section, the exposure time is set to be 260 msec, regarding the product chips (b, c) in the upper section thereof, the exposure time is set to be 290 msec, regarding the product chips (m, p) on the both sides of the lower area, the exposure time is set to be 310 msec, and regarding the rest of the product chips (a, d, e, h, i, l, n, o), the exposure time is set to be 300 msec.

Therefore, along the classification as described above, the total irradiation time during which the shutter 3 is kept open is set to be 310 msec, and the liquid crystal blind 17 is controlled in the irradiation time so as to obtain the four levels of irradiation patterns shown in FIGS. 8A through 8D.

Specifically, in the product chips (a through p) of the entire area irradiation pattern shown in FIG. 8A, the irradiation time is in a range of 0 through 260 msec, and in the product chips (a, b, c, d, e, h, i, l, m, n, o, p) of the first partial area irradiation pattern shown in FIG. 8B, the irradiation time is in a range of 260 through 290 msec. Further, in the product chips (a, d, e, h, i, l, m, n, o, p) of the second partial area irradiation pattern shown in FIG. 8C, the irradiation time is in a range of 290 through 300 msec, and in the product chips (m, p) of the third partial area irradiation pattern shown in FIG. 8D, the irradiation time is in a range of 300 through 310 msec. It should be noted that the entire area non-irradiation pattern shown in FIG. 8E is obtained by the controller 14 controlling the shutter 3 to set the state (in the projection area) of the liquid crystal blind 17 before (before FIG. 8A) the irradiation by the irradiation light or after (after FIG. 8D) the irradiation to be the entire surface light-blocking state.

FIG. 9 shows measurement results of the dimensions of the product chips (a through p) projected and exposed in such a procedure. With reference to FIG. 9, it is understood that the average dimension in the exposure shot surface of the product chips (a through p) becomes 1.00 μm, which is equal to the design value, and the dimensional accuracy is remarkably improved to be 3.0%.

It should be noted that although in the reduced projection exposure apparatus according to the first and second embodiment described above, there is explained the configuration, in which the shutter 3 capable of controlling the irradiation time of the irradiation light by the open/closed state thereof is provided, the controller 14 is made to perform the open/close control of the shutter 3 so that an incident light with an appropriate irradiation time can be obtained in the liquid crystal blind 17, the controller 14 is also made to perform the control of the voltage application to the liquid crystal blind 17 for variably setting the irradiation area of the irradiation light applied on the reticle 10 in a follow-up manner, thereby making it possible to more stably perform assurance of the dimensional accuracy of the resist pattern image by the projection exposure, since the liquid crystal blind 17 in this case also has the function of the shutter 3 as explained in the description of the entire surface light-blocking state of the entire area non-irradiation pattern shown in FIG. 8E, the configuration without the shutter 3 can also be adopted. Also in such a case, assurance of the dimensional accuracy of the resist pattern image by the projection exposure can similarly be performed in a stable manner.

In the reduced projection exposure apparatus with such a configuration, it is possible to arrange that the irradiation area data stored in the storage device 15 includes the entire surface light-blocking data for setting the projection area of the reticle 10 to be the entire surface light-blocking state when no projection exposure is performed, and to have the function that the controller 14 controls the liquid crystal blind 17 before and after the irradiation by the irradiation light based on the entire surface light-blocking data to set the projection area of the reticle 10 to be the entire surface light-blocking state.

In other words, when, for example, the entire optical opening section of the liquid crystal blind 17 is set to be the closed state due to the action of the storage device 15 and the controller 14 based on the entire surface light-blocking data before and after the irradiation of the irradiation light, namely when no projection exposure is conducted, the inside of the projection area of the reticle 10 is set to be the entire surface light-blocking state to make it possible to obtain the function of the shutter 3, and therefore, it becomes possible to eliminate the need for using the shutter 3 in the irradiation optical system.

It is indicated that it is possible that in the case in which such a function is applied as the method of manufacturing a semiconductor device, the irradiation area data used in the exposure condition setting stage includes the entire surface light-blocking data for setting the inside of the projection area of the reticle 10 to be the entire surface light-blocking state when no projection exposure is conducted, the liquid crystal blind 17 is controlled to set the inside of the projection area of the reticle 10 to be the entire surface light-blocking state before and after the irradiation of the irradiation light along the entire surface light-blocking data.

In the first and second embodiments described above, either one of the lengthwise transparent electrode 171 and the lateral transparent electrode 172 corresponds to a “first electrode layer,” and the other of the lengthwise transparent electrode 171 and the lateral transparent electrode 172 corresponds to a “second electrode layer.”

The entire disclosure of Japanese Patent Application Nos: 2008-145564, filed Jun. 3, 2008 and 2009-072394, filed Mar. 24, 2009 are expressly incorporated by reference herein.

What is claimed is:

1. A liquid crystal blind, comprising:
a transparent first electrode layer;
a transparent second electrode layer intersecting with the first electrode layer; and
a liquid crystal cell formed between the first electrode layer and the second electrode layer, a voltage being applied between the first electrode layer and the second electrode layer according to an irradiation area adapted to apply irradiation light to a semiconductor substrate and determining an irradiation pattern.

2. The liquid crystal blind according to claim 1, the liquid crystal cell being controlled so as to determine an irradiation time in accordance with the irradiation area.

3. A method of manufacturing a semiconductor device using a liquid crystal blind having a plurality of liquid crystal cells and driven by a liquid crystal drive method, the method comprising:
determining an irradiation pattern by applying a voltage to each of the liquid crystal cells; and
conducting projection exposure via the irradiation pattern.

4. The method of manufacturing a semiconductor device according to claim 3, the liquid crystal blind further including a first electrode layer extending in a first direction and a second electrode layer extending in a second direction intersecting with the first direction, the irradiation pattern being formed by controlling a voltage application to the first electrode layer and the second electrode layer.

5. The method of manufacturing a semiconductor device according to claim 4, the voltage application being controlled based on irradiation time data corresponding to an area on which the projection exposure is conducted.

6. The method of manufacturing a semiconductor device according to claim 3, further comprising:
setting an entire surface light-blocking state before and after conducting the projection exposure.

7. A reduced projection exposure apparatus comprising:
a liquid crystal blind having a plurality of liquid crystal cells and driven by a liquid crystal drive method;
a storage device storing an exposure control program; and
a controller determining an irradiation pattern of the liquid crystal blind with the exposure control program.

8. The reduced projection exposure apparatus according to claim 7, further comprising:
a source of luminescence emitting an irradiation light;
a shutter having an open and closed states controlled by the controller, the shutter transmitting the irradiation light.

9. The reduced projection exposure apparatus according to claim 8, the controller configured to control the shutter to be the open state after controlling the irradiation pattern of the liquid crystal blind.
